(19) United States
(12) Patent Application Publication
(10) Pub. No.: US 2023/0351479 A1
(43) Pub. Date: Nov. 2, 2023

(54) Digital Marketplace

(71) Applicant: CenturyLink Intellectual Property LLC, Broomfield, CO (US)

(72) Inventors: Gurpreet S. Sidhu, Aurora, CO (US); Mark Alan Ramach, Seattle, WA (US); John Nava, Parker, CO (US); Scott Berns, Arvada, CO (US)

(73) Assignee: CenturyLink Intellectual Property LLC, Broomfield, CO (US)

(21) Appl. No.: 18/302,283

(22) Filed: Apr. 18, 2023

Related U.S. Application Data
(60) Provisional application No. 63/336,125, filed on Apr. 28, 2022.

(51) Int. Cl. G06Q 30/0601; H04L 41/0806; G06Q 10/083; H04L 41/50

(52) U.S. Cl. CPC G06Q 30/0635; G06Q 10/083; G06Q 30/0641; H04L 41/0806; H04L 41/50; G06F 3/0482

(57) ABSTRACT

Novel tools and techniques are provided for implementing a digital marketplace for providing a user experience (“UX”) for customers to order and configure network services that are subsequently autonomously provisioned via a network(s). In various embodiments, a digital marketplace is provided for providing a UX for customers to order and configure network services or telephony services that are subsequently autonomously provisioned via a network(s), in some cases, autonomously provisioning and (pre)configuring, on customer premises equipment (“CPE”), network services or telephony services that are purchased via the UX, either before shipping the CPE or after the CPE has been shipped to, and installed at, the customer premises.

### CROSS-REFERENCES TO RELATED APPLICATIONS

This application claims priority to U.S. Pat. Application Ser. No. 63/336,125 (the “ ‘125 Application”), filed Apr. 28, 2022, by Gary Sidhu et al. (attorney docket no. 1708-US-P1), entitled, “Digital Marketplace,” the disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing network service ordering and provisioning, and, more particularly, to methods, systems, and apparatuses for implementing a digital marketplace for providing a user experience (“UX”) for customers to order and configure network services that are subsequently autonomously provisioned via a network(s).

### BACKGROUND

Although conventional marketplaces provide customers with the ability to purchase software and tangible objects, conventional marketplaces fail to provide customers the ability to purchase network services or telephony services nor provide customers the ability to preconfigure such network services or telephony services or to autonomously deploy purchased network services or telephony services that have been preconfigured.

Hence, there is a need for more robust and scalable solutions for implementing network service ordering and provisioning, and, more particularly, to methods, systems, and apparatuses for implementing a digital marketplace for providing a user experience (“UX”) for customers to order and configure network services that are subsequently autonomously provisioned via a network(s).

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components. For denoting a plurality of components, the suffixes “a” through “n,” where n denotes any suitable integer number, and may be either the same or different from the suffix “n” for other components in the same or different figures. For example, for component #1 105a-105n, the integer value of n in 105n may be the same or different from the integer value of n in 110n for component #2 110a-110n, and so on.

FIG. 1 is a schematic diagram illustrating a system for implementing a digital marketplace for providing a user experience (“UX”) for customers to order and configure network services that are subsequently autonomously provisioned via a network(s), in accordance with various embodiments.

FIG. 2 is a schematic diagram illustrating another system for implementing a digital marketplace for providing a UX for customers to order and configure network services that are subsequently autonomously provisioned via a network(s), in accordance with various embodiments.

FIGS. 3A-3I are diagrams illustrating various non-limiting examples of user interface(s) or UXs of a digital marketplace that may be provided for customers to order and configure network services that are subsequently autonomously provisioned via a network(s), in accordance with various embodiments.

FIGS. 4A-4D are flow diagrams illustrating a method for implementing a digital marketplace for providing a UX for customers to order and configure network services that are subsequently autonomously provisioned via a network(s), in accordance with various embodiments.

FIG. 5 is a block diagram illustrating an exemplary computer or system hardware architecture, in accordance with various embodiments.

FIG. 6 is a block diagram illustrating a networked system of computers, computing systems, or system hardware architecture, which can be used in accordance with various embodiments.

### DETAILED DESCRIPTION OF CERTAIN EMBODIMENTS

### Overview

Various embodiments provide tools and techniques for implementing network service ordering and provisioning, and, more particularly, to methods, systems, and apparatuses for implementing a digital marketplace for providing a user experience (“UX”) for customers to order and configure network services that are subsequently autonomously provisioned via a network(s).

In various embodiments, a digital marketplace is provided for providing a UX for customers to order and configure network services or telephony services that are subsequently autonomously provisioned via a network(s), in some cases, autonomously provisioning and (pre)configuring, on customer premises equipment (“CPE”), network services or telephony services that are purchased via the UX, either before shipping the CPE or after the CPE has been shipped to, and installed at, the customer premises.

These and other aspects of the digital marketplace for providing a UX for customers to order and configure network services that are subsequently autonomously provisioned via a network(s) are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

In an aspect, a method may comprise: providing, using a computing system, a user experience (“UX”) platform for a digital marketplace, the UX platform being accessible by a user via a user device over one or more networks; providing, using the computing system and via the UX platform, one or more options to purchase, via the digital marketplace, one or more network services among a plurality of network services provided by a service provider; providing, using the computing system and via the UX platform, one or more options to preconfigure any purchased network services among the one or more network services; in response to an order being initiated by the user and in response to receiving a first user selection of at least one option to purchase at least one network service and a second user selection of at least one option to preconfigure the at least one network service, autonomously processing, using the computing system, the order for the at least one network service to be provisioned to the user based at least in part on the first user selection and the second user selection; based on a determination that the user already has a customer premises equipment (“CPE”) installed and operational at a customer premises associated with the user or with an entity with which the user is associated, autonomously provisioning, using the computing system, the at least one network service on the CPE based on the first user selection, and autonomously preconfiguring, using the computing system, the provisioned at least one network service based on the second user selection; based on a determination that the user does not currently have a CPE installed and operational at the customer premises and based on a determination that a CPE has already been shipped to the customer premises, sending, using the computing system, a set of instructions for the user to install the CPE at the customer premises, and in response to determining that the CPE has been successfully installed at the customer premises, autonomously provisioning, using the computing system, the at least one network service on the CPE based on the first user selection, and autonomously preconfiguring, using the computing system, the provisioned at least one network service based on the second user selection; and based on a determination that the user does not currently have a CPE installed and operational at the customer premises and based on a determination that a CPE has not already been shipped to the customer premises, assigning, using the computing system, a CPE to at least one of the entity, the user, or the customer premises, provisioning, using the computing system, the at least one network service on the assigned CPE based on the first user selection, preconfiguring, using the computing system, the provisioned at least one network service based on the second user selection, and shipping the assigned CPE to the customer premises with instructions for installing the assigned CPE.

Alternatively, the method may comprise: in response to an order being initiated by the user and in response to receiving a first user selection of at least one option to purchase at least one network service and a second user selection of at least one option to preconfigure the at least one network service, autonomously processing, using the computing system, the order for the at least one network service to be provisioned to the user based at least in part on the first user selection and the second user selection, the first and second user selections being made using a user experience (“UX”) platform for a digital marketplace, the UX platform being accessible by the user via a user device over one or more networks; based on a determination that the user already has a customer premises equipment (“CPE”) installed and operational at a customer premises associated with the user or with an entity with which the user is associated, autonomously provisioning, using the computing system, the at least one network service on the CPE based on the first user selection, and autonomously preconfiguring, using the computing system, the provisioned at least one network service based on the second user selection; based on a determination that the user does not currently have a CPE installed and operational at the customer premises and based on a determination that a CPE has already been shipped to the customer premises, sending, using the computing system, a set of instructions for the user to install the CPE at the customer premises, and in response to determining that the CPE has been successfully installed at the customer premises, autonomously provisioning, using the computing system, the at least one network service on the CPE based on the first user selection, and autonomously preconfiguring, using the computing system, the provisioned at least one network service based on the second user selection; and based on a determination that the user does not currently have a CPE installed and operational at the customer premises and based on a determination that a CPE has not already been shipped to the customer premises, assigning, using the computing system, a CPE to at least one of the entity, the user, or the customer premises, provisioning, using the computing system, the at least one network service on the assigned CPE based on the first user selection, preconfiguring, using the computing system, the provisioned at least one network service based on the second user selection, and shipping the assigned CPE to the customer premises with instructions for installing the assigned CPE.

In some embodiments, the computing system may comprise at least one of a web-based digital marketplace computing system, a portal-based digital marketplace computing system, a software application (“app”) -based digital marketplace computing system, a server computer, a customer interface server, a network service reservation and ordering platform server, a gateway controller, a network provisioning server, a cloud computing system, or a distributed computing system, and/or the like. In some instances, the plurality of network services may comprise at least one of a plurality of network service apps, one or more Internet services, one or more wide area network (“WAN”) services, one or more software-defined WAN (“SD-WAN”) services, one or more network security services, one or more telephony services, one or more voice over Internet Protocol (“VoIP) services, or other network services, and/or the like. In some cases, the customer premises may comprise one of a residential customer premises, a business customer premises, a corporate customer premises, an enterprise customer premises, an education facility customer premises, a medical facility customer premises, or a governmental customer premises, and/or the like.

According to some embodiments, autonomously provisioning the at least one network service on the CPE may comprise autonomously deploying the at least one network service on the CPE from a network edge platform in proximity to the customer premises.

In some embodiments, the method may further comprise at least one of: initiating, using the computing system, one or more network service updates for the at least one network service via the CPE; facilitating, using the computing system, service registration of the at least one network service via the CPE; implementing, using the computing system, one or more post-configuration settings for the at least one network service via the CPE; tracking, using the computing system, performance of the at least one network service via the CPE; or providing, using the computing system, one or more of analytics or insights associated with functioning of the at least one network service to the user; and/or the like.

In some instances, the at least one network service may comprise at least one network service app, wherein: the one or more network service updates comprise one or more network service app updates; the service registration comprises network service app registration; the one or more post-configuration settings comprise network service app configuration settings; the performance of the at least one network service comprises network service app performance; and one or more of analytics or insights associated with functioning of the at least one network service comprises network service app analytics and insights; and/or the like.

According to some embodiments, the method may further comprise providing, using a computing system, a user experience (“UX”) platform for a digital marketplace, the UX platform being accessible by a user via a user device over one or more networks; providing, using the computing system and via the UX platform, one or more options to purchase, via the digital marketplace, one or more network services among a plurality of network services provided by a service provider; and providing, using the computing system and via the UX platform, one or more options to preconfigure any purchased network services among the one or more network services.

In some embodiments, the method may further comprise generating and presenting, using the computing system and within the UX platform, a visualization of the at least one network service. In some instances, the method may further comprise, in response to receiving at least one of the first user selection or the second user selection, placing, using the computing system, the at least one network service in a shopping cart of the UX platform; and providing, using the computing system and via the UX platform, one or more options to visualize the at least one network service that has been added to the shopping cart. In some cases, generating and presenting the visualization of the at least one network service may be in response to receiving a third user selection of at least one option to visualize the at least one network service that has been added to the shopping cart. Alternatively, or additionally, generating and presenting the visualization of the at least one network service may (further) comprise generating and presenting, using the computing system and within the UX platform, a visualization of the at least one network service in relation to other network services associated with at least one of the entity, the user, or the customer premises, and/or the like. Alternatively, or additionally, generating and presenting the visualization of the at least one network service may (further) comprise determining, using the computing system, geographical locations or coverages of the at least one network service and any other network services associated with at least one of the entity, the user, or the customer premises relative to one or more geographical locations associated with the at least one of the entity, the user, or the customer premises; and, based on such determination, generating and presenting, using the computing system and within the UX platform, a map-based visualization of the at least one network service in relation to other network services associated with at least one of the entity, the user, or the customer premises and in relation to the one or more geographical locations associated with the at least one of the entity, the user, or the customer premises.

In another aspect, a system may comprise a computing system, which may comprise at least one first processor and a first non-transitory computer readable medium communicatively coupled to the at least one first processor. The first non-transitory computer readable medium may have stored thereon computer software comprising a first set of instructions that, when executed by the at least one first processor, causes the computing system to: in response to an order being initiated by the user and in response to receiving a first user selection of at least one option to purchase at least one network service and a second user selection of at least one option to preconfigure the at least one network service, autonomously process the order for the at least one network service to be provisioned to the user based at least in part on the first user selection and the second user selection, the first and second user selections being made using a user experience (“UX”) platform for a digital marketplace, the UX platform being accessible by the user via a user device over one or more networks; based on a determination that the user already has a customer premises equipment (“CPE”) installed and operational at a customer premises associated with the user or with an entity with which the user is associated, autonomously provision the at least one network service on the CPE based on the first user selection, and autonomously preconfigure the provisioned at least one network service based on the second user selection; based on a determination that the user does not currently have a CPE installed and operational at the customer premises and based on a determination that a CPE has already been shipped to the customer premises, send a set of instructions for the user to install the CPE at the customer premises, and in response to determining that the CPE has been successfully installed at the customer premises, autonomously provision the at least one network service on the CPE based on the first user selection, and autonomously preconfigure the provisioned at least one network service based on the second user selection; and based on a determination that the user does not currently have a CPE installed and operational at the customer premises and based on a determination that a CPE has not already been shipped to the customer premises, assign a CPE to at least one of the entity, the user, or the customer premises, provision the at least one network service on the assigned CPE based on the first user selection, preconfigure the provisioned at least one network service based on the second user selection, and ship the assigned CPE to the customer premises with instructions for installing the assigned CPE.

In some embodiments, the computing system may comprise at least one of a web-based digital marketplace computing system, a portal-based digital marketplace computing system, a software application (“app”) -based digital marketplace computing system, a server computer, a customer interface server, a network service reservation and ordering platform server, a gateway controller, a network provisioning server, a cloud computing system, or a distributed computing system, and/or the like. In some instances, the plurality of network services may comprise at least one of a plurality of network service apps, one or more Internet services, one or more wide area network (“WAN”) services, one or more software-defined WAN (“SD-WAN”) services, one or more network security services, one or more telephony services, one or more voice over Internet Protocol (“VoIP) services, or other network services, and/or the like.

In yet another aspect, a method may comprise providing, using a computing system, a user experience (“UX”) platform for a digital marketplace with which to order provisioning of network services to a customer premises that is associated with a user or with an entity with which the user is associated, with consistent user purchase experience without interaction with sales personnel associated with a service provider providing the network services, the UX platform being accessible by the user via a user device over one or more networks. In some cases, the network services may comprise at least one of one or more network service apps, one or more Internet services, one or more wide area network (“WAN”) services, one or more software-defined WAN (“ SD-WAN”) services, one or more network security services, one or more telephony services, one or more voice over Internet Protocol (“VoIP) services, or other network services, and/or the like.

In some embodiments, the computing system may comprise at least one of a web-based digital marketplace computing system, a portal-based digital marketplace computing system, a software application (“app”) -based digital marketplace computing system, a server computer, a customer interface server, a network service reservation and ordering platform server, a gateway controller, a network provisioning server, a cloud computing system, or a distributed computing system, and/or the like.

According to some embodiments, the method may further comprise providing, using the computing system and via the UX platform, one or more options to visualize one or more network services that the user has added to a shopping cart of the UX platform to order provisioning of the one or more network services; and, in response to receiving a third user selection of at least one option to visualize the at least one network service that has been added to the shopping cart, generating and presenting, using the computing system and within the UX platform, a visualization of the one or more network services. In some instances, generating and presenting the visualization of the one or more network services may comprise generating and presenting, using the computing system and within the UX platform, a visualization of the one or more network services in relation to other network services associated with at least one of the entity, the user, or the customer premises, and/or the like. Alternatively, or additionally, generating and presenting the visualization of the one or more network services may comprise: determining, using the computing system, geographical locations or coverages of the one or more network services and any other network services associated with at least one of the entity, the user, or the customer premises relative to one or more geographical locations associated with the at least one of the entity, the user, or the customer premises; and, based on such determination, generating and presenting, using the computing system and within the UX platform, a map-based visualization of the one or more network services in relation to other network services associated with at least one of the entity, the user, or the customer premises and in relation to the one or more geographical locations associated with the at least one of the entity, the user, or the customer premises.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

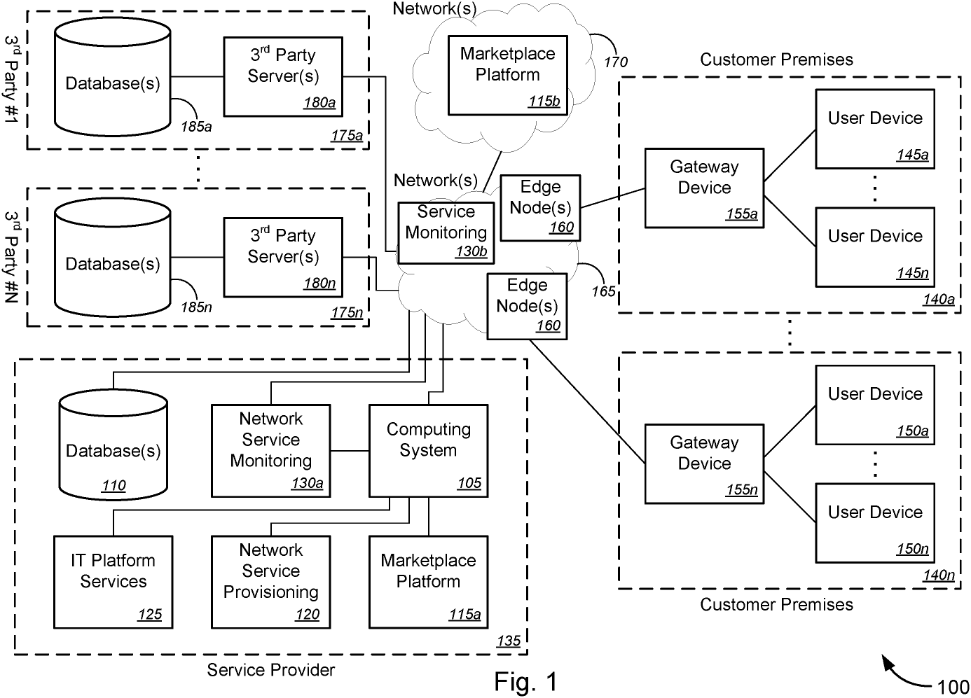

We now turn to the embodiments as illustrated by the drawings. FIGS. 1-6 illustrate some of the features of the method, system, and apparatus for implementing network service ordering and provisioning, and, more particularly, to methods, systems, and apparatuses for implementing a digital marketplace for providing a user experience (“UX”) for customers to order and configure network services that are subsequently autonomously provisioned via a network(s), as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 is a schematic diagram illustrating a system 100 for implementing a digital marketplace for providing a user experience (“UX”) for customers to order and configure network services that are subsequently autonomously provisioned via a network(s), in accordance with various embodiments.

In the non-limiting embodiment of FIG. 1, system 100 may comprise computing system 105, database(s) 110, marketplace platform 115a, network service provisioning system 120, IT platform services 125, and network service monitoring system 130a, each associated with a service provider 135. In some embodiments, disposed within customer premises 140a-140n (collectively, “customer premises 140” or the like), each associated with a customer or user, may be one or more user devices 145a-145n and/or 150a-150n (collectively, “user devices 145 and/or 150” or the like), each communicatively coupled to one of gateway devices 155a-155n (collectively, “gateway devices 155” or the like; which may include customer premises equipment (“CPE”) or universal CPE (“uCPE”), or the like). System 100 may further comprise one or more edge nodes 160 disposed in one or more networks 165, which may be operated or provided by service provider 135 or a different service provider (not shown).

According to some embodiments, alternative or additional to marketplace platform 115a, system 100 may (further) comprise marketplace platform 115b disposed within network(s) 170, which may be associated with a different service provider compared with the service provider 135 and/or the service provider for operating or providing the one or more networks 165.

In some embodiments, system 100 may further comprise one or more third parties 175a-175n, each with corresponding third party server(s) 180 (including third party server(s) 180a-180n, or the like) and corresponding database(s) 185 (including database(s) 185a-185n, or the like). The third parties 175a-175n may provide software applications or other services for customers to purchase on the marketplace platform 115a and/or 115b.

According to some embodiments, network(s) 165 and/or 170 may each include, without limitation, one of a local area network (“LAN”), including, without limitation, a fiber network, an Ethernet network, a Token-Ring® network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth® protocol known in the art, and/or any other wireless protocol; and/or any combination of these and/or other networks. In a particular embodiment, the network(s) 165 and/or 170 may include an access network of the service provider (e.g., an Internet service provider (“ISP”)). In another embodiment, the network(s) 165 and/or 170 may include a core network of the service provider and/or the Internet.

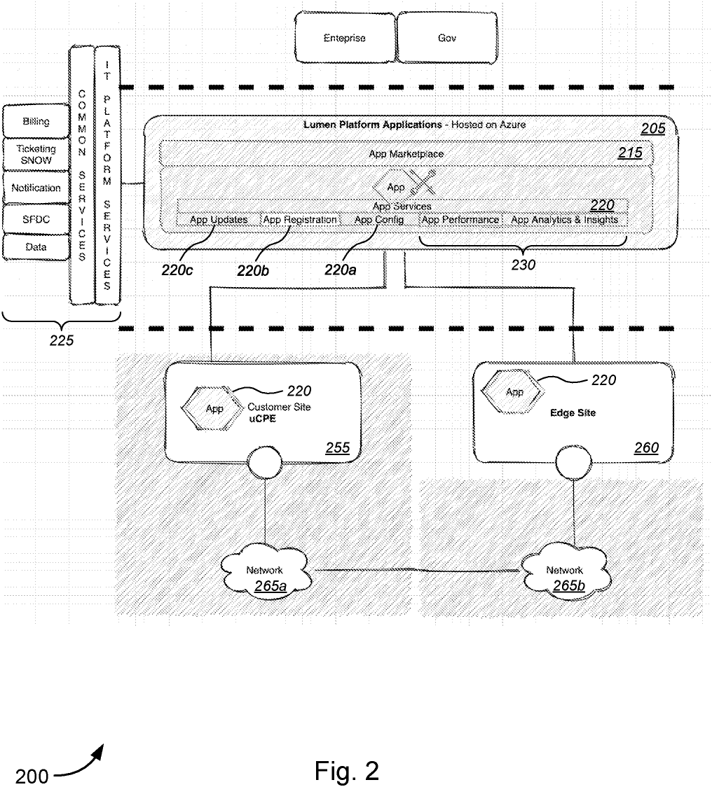

In operation, the computing system 105, marketplace platform 115a and/or 115b, network service provisioning 120, IT platform services 125, network service monitoring 130a and/or 130b (collectively, “computing system” or the like) may perform methods for providing a UX for customers to order and configure network services or telephony services that are subsequently autonomously provisioned via a network(s), in some cases, autonomously deploying, on customer premises equipment (“CPE”) or gateway device(s) 155, purchased network services or telephony services that have been preconfigured, as described in detail with respect to FIGS. 2-4.

These and other functions of the system 100 (and its components) are described in greater detail below with respect to FIGS. 2-4.

FIG. 2 is a schematic diagram illustrating another system 200 for implementing a digital marketplace for providing a UX for customers to order and configure network services that are subsequently autonomously provisioned via a network(s), in accordance with various embodiments. In some embodiments, network services may be embodied by network service software applications (“apps”).

System 200 may comprise service provider platform applications or systems 205, digital marketplace 215, one or more app services 220, IT platform services 225 (including, but not limited to, common services, including, without limitation, billing services, ticketing services, notifications, SFDC systems, data systems, and/or the like), app performance and/or analytics and insights systems 230, uCPE (or customer premises) 255, edge node(s) (or edge node location) 260, and network(s) 265a-265b, and/or the like. In some cases, the app services 220 may include at least one of app configuration 220a, app registration 220b, and/or app updates 220c, and/or the like.

In some embodiments, service provider platform applications or systems 205, digital marketplace 215, IT platform services 225, app performance and/or analytics and insights systems 230, uCPE (or customer premises) 255, edge node(s) (or edge node location) 260, and network(s) 265a-265b of system 200 of FIG. 2 may correspond to computing system 105, marketplace 115a or 115b, IT platform services system 125, network service monitoring system 130a or 130b, gateway device 155a-155n (or customer premises 140a-140n), edge node(s) 160, and network(s) 165 and/or 170 of system 100 of FIG. 1, respectively, and the descriptions of these components of system 100 are applicable to the corresponding components of system 200, respectively.

These and other functions of the system 200 (and its components) are described in greater detail below with respect to FIGS. 1, 3, and 4.

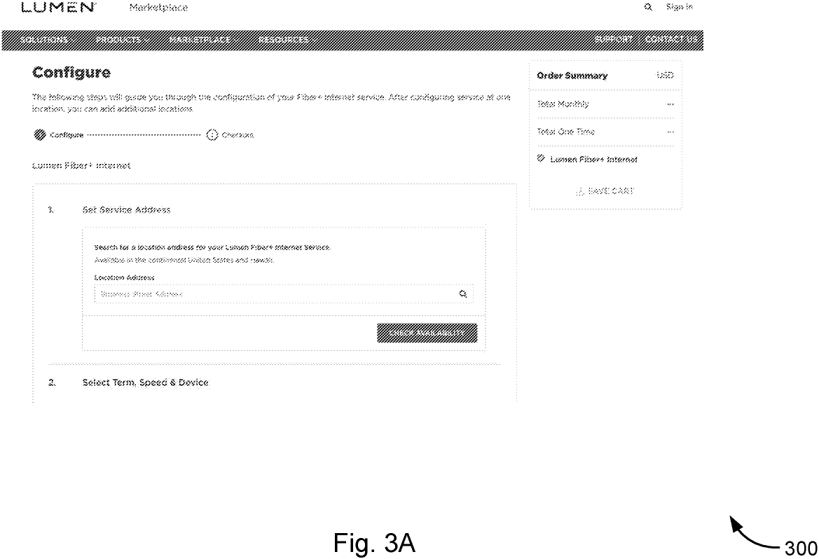

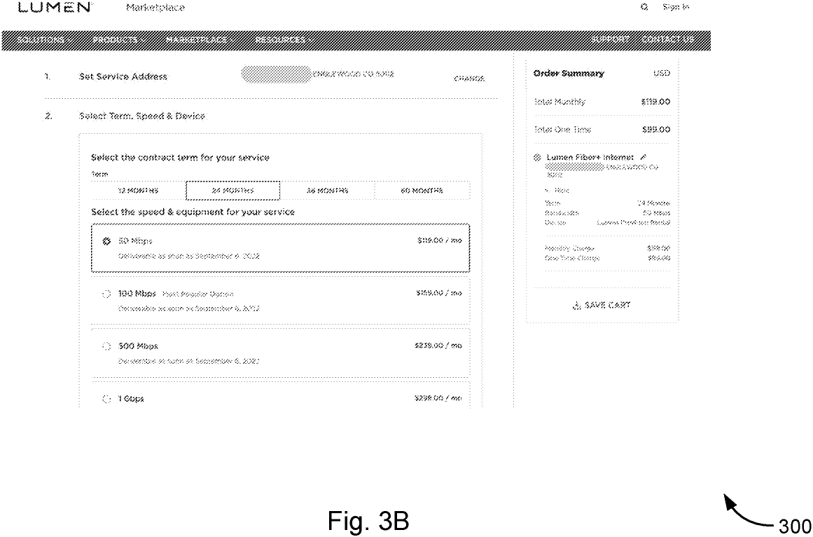

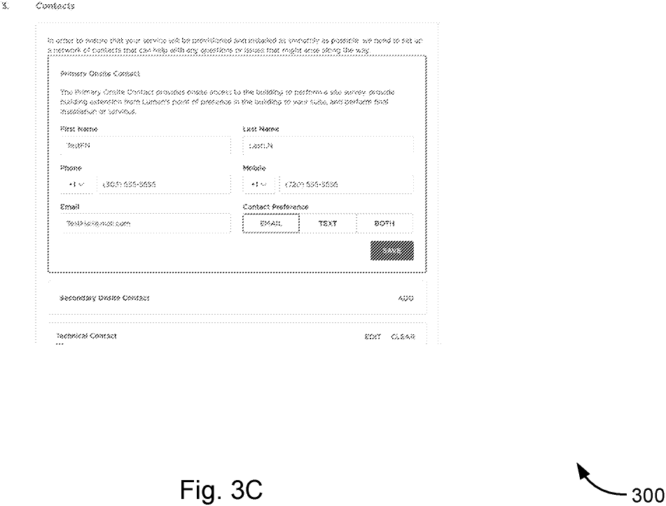

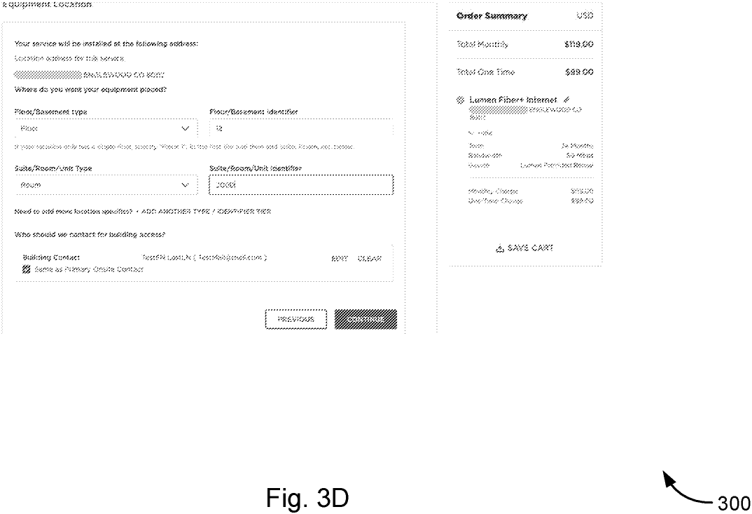

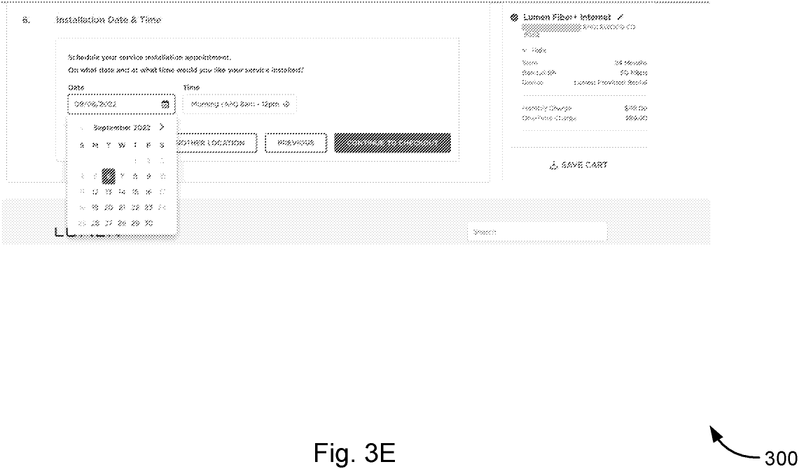

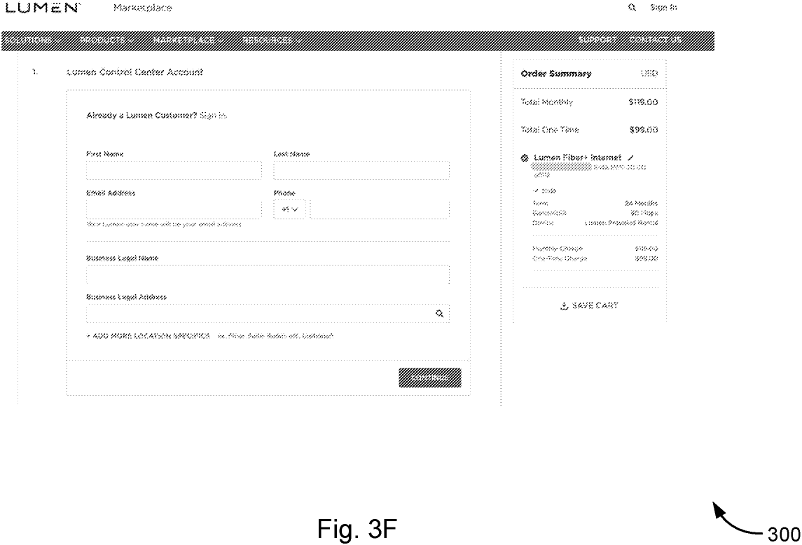

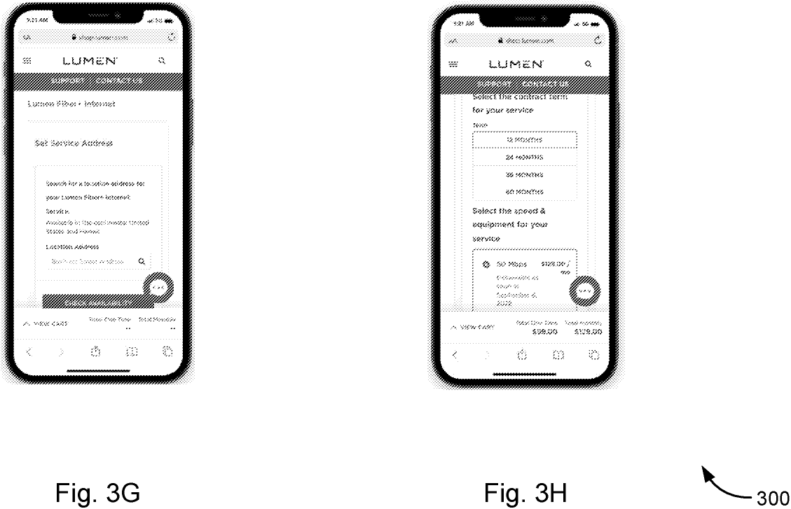

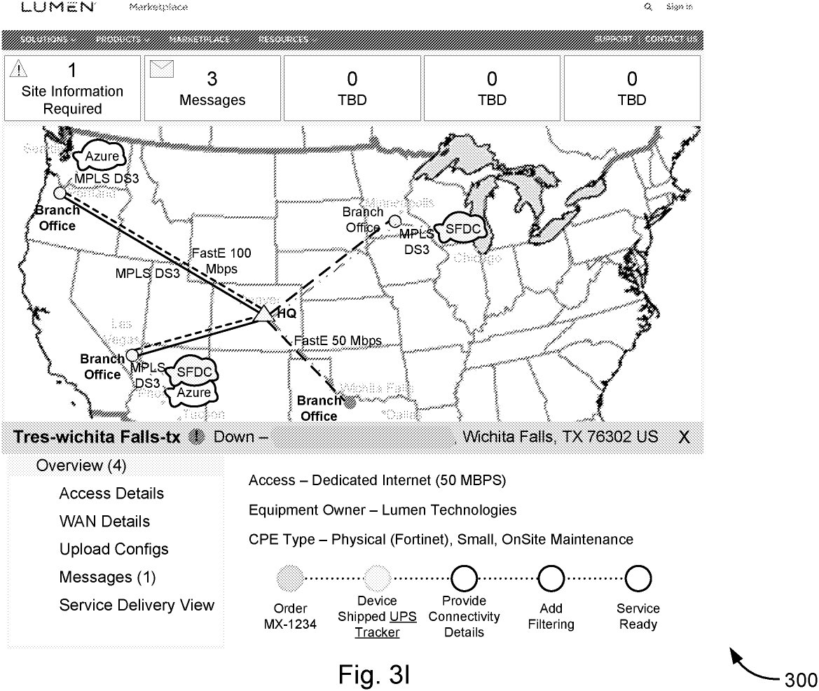

FIGS. 3A-3I (collectively, “FIG. 3”) are diagrams illustrating various non-limiting examples of user interface(s) (“UI(s)”) or UXs of a digital marketplace that may be provided for customers to order and configure network services that are subsequently autonomously provisioned via a network(s), in accordance with various embodiments.

FIGS. 3A-3F depict various UIs or UXs of a digital marketplace that is provided for customers to order and configure network services (including, but not limited to, optical fiber services and/or Internet services, or the like), by providing various fields or UI/UX panels including, without limitation, those for setting service address (FIG. 3A), selecting terms, speed, and device (FIG. 3B), providing contact information (FIG. 3C), setting equipment location (FIG. 3D), setting installation date and time (FIG. 3E), logging into a control center account (FIG. 3F), and/or the like. FIGS. 3G and 3H depict a mobile device app for providing the UIs or UXs of the digital marketplace for performing similar functionalities.

FIG. 3I depicts a UI or UX panel for presenting a visualization (in this case, in map form) of one or more network services that have been added to a shopping cart of the UX platform or have already been ordered, which in some cases may be in relation to other network services associated with at least one of an entity with which the user or customer is associated, the user or the customer, or the customer premises with which the one or more network services (that are being ordered and that have been added to the shopping cart) are associated. As shown in FIG. 3I, for an entity that has a headquarters (“HQ”) in one location and one or more branch offices in other geographic locations, the collective network services may include, without limitation, one or more fast Ethernet (“fastE”) connections (e.g., FastE 100 Mbps, FastE 50 Mbps, etc.) between the HQ and a branch office, one or more multiprotocol label switching (“MPLS”) connections (e.g., a ~ 64 Kbps digital signal level zero (“DS0”) channel connection, a ~ 1.5 Mbps digital signal level one (“DS1”) or T-carrier 1 (“T1”) channel connection, a ~ 45 Mbps digital signal level three (“DS3 ”) or T-carrier 3 (“T3”) channel connection, or the like) between the HQ and a branch office, between a branch office and a data center (e.g., SFDC, or the like), or between a branch office and a cloud service(s) (e.g., Microsoft Azure® cloud service(s) or cloud computing platform, or the like), or the like.

In some embodiments, the visualization may indicate whether and where a location or office is down (or not operating normally or at all; e.g., the Branch Office located in Wichita Falls, Texas in the non-limiting example of FIG. 3I, or the like), and may also present an overview section that includes options for displaying additional information (including, but not limited to, access details, wide area network (“WAN”) details, upload configurations, messages, service delivery view, and/or the like. In the non-limiting example of FIG. 3I, information regarding the downed network service may include access information (e.g., Dedicated Internet (50 Mbps), which may be provided by FastE 50 Mbps connection, or the like), equipment owner information (e.g., indicating the Lumen Technologies is the owner of the equipment, or the like), customer premises equipment (“CPE”) information (e.g., indicating physical equipment (e.g., Fortinet, etc.), small, onsite maintenance, etc.), and/or the like. In some cases, the UI or UX platform may also indicate the progress of processes to address the downed network service, in this case, ordering of replacement equipment (which is denoted by the darker-shaded circle indicating order completed), shipping status of the replacement equipment (which is denoted by the lighter-shaded circle indicating order shipped and in transit with link to UPS tracker or the like), providing connectivity details (which is denoted by a black-bordered white circle indicating not yet available, or the like), adding filtering (which is denoted by a black-bordered white circle indicating not yet available, or the like), and service being ready (which is denoted by a black-bordered white circle indicating not yet available, or the like), and/or the like. In some instances, the UI or UX platform may also display alert fields, including, but not limited to, one or more fields indicating information is required, one or more fields indicating that there are messages available, and/or the like. Although FIG. 3I depicts a particular example, the various embodiments are not so limited, and FIG. 3I is intended to be an illustration of visualization of network services that are available through the digital marketplace UI or UX platform, in some cases, showing relationship with existing network services (as well as relevant information for existing network services, ordered network services, or network services that are being ordered, such relevant information including, but not limited to, network, connectivity, and/or equipment information, or the like), the existing network services being associated with the user or customer or entity that is interacting with the UI or UX platform, or the like.

These and other functions of the system 200 (and its components) are described in greater detail below with respect to FIGS. 1, 2, and 4.

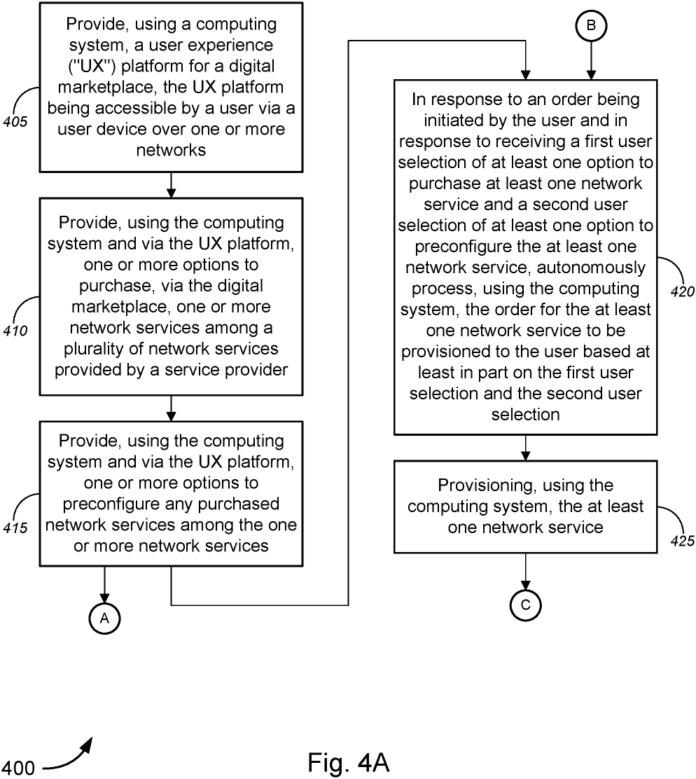

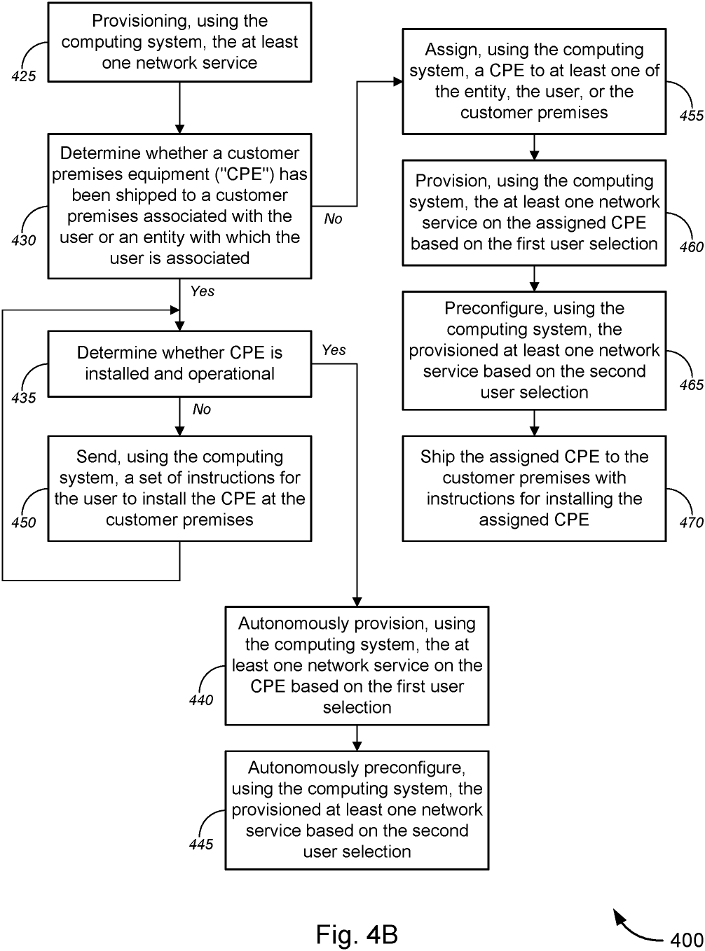

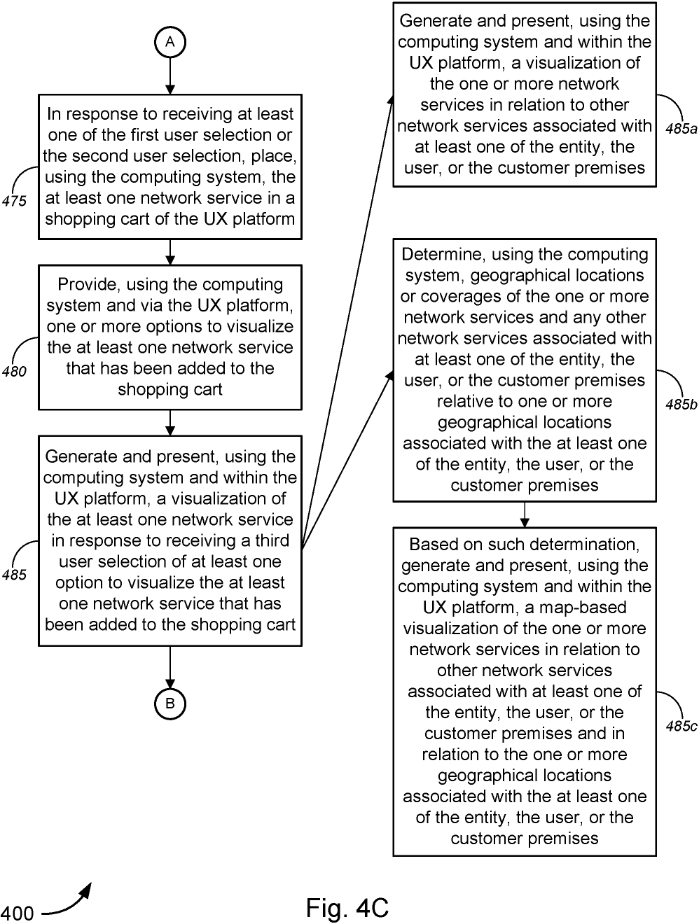

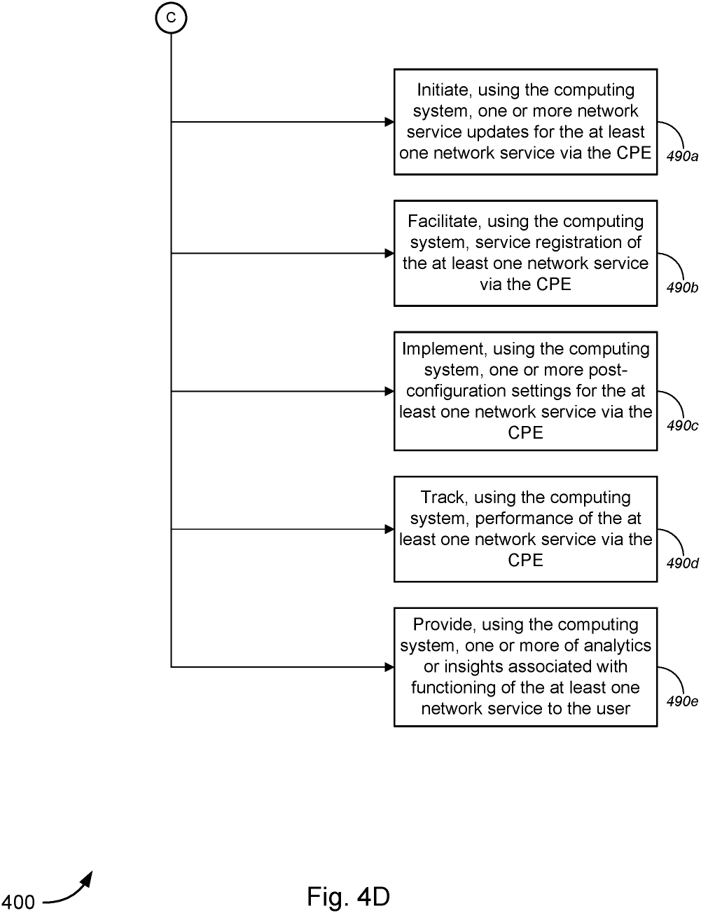

FIGS. 4A-4D (collectively, “FIG. 4”) are flow diagrams illustrating a method for implementing a digital marketplace for providing a UX for customers to order and configure network services that are subsequently autonomously provisioned via a network(s), in accordance with various embodiments. Method 400 of FIG. 4A continues onto FIG. 4C following the circular marker denoted, “A,” and returns to FIG. 4A following the circular marker denoted, “B.” Method 400 of FIG. 4A continues onto FIG. 4D following the circular marker denoted, “C,”

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems, examples, or embodiments 100, 200, and 300 of FIGS. 1, 2, and 3, respectively (or components thereof), such methods may also be implemented using any suitable hardware (or software) implementation. Similarly, while each of the systems, examples, or embodiments 100, 200, and 300 of FIGS. 1, 2, and 3, respectively (or components thereof), can operate according to the method 400 illustrated by FIG. 4 (e.g., by executing instructions embodied on a computer readable medium), the systems, examples, or embodiments 100, 200, and 300 of FIGS. 1, 2, and 3 can each also operate according to other modes of operation and/or perform other suitable procedures.

In the non-limiting embodiment of FIG. 4A, method 400, at block 405, may comprise providing, using a computing system, a user experience (“UX”) platform for a digital marketplace, the UX platform being accessible by a user via a user device over one or more networks. At block 410, method 400 may comprise providing, using the computing system and via the UX platform, one or more options to purchase, via the digital marketplace, one or more network services among a plurality of network services provided by a service provider. Method 400 may further comprise, at block 415, providing, using the computing system and via the UX platform, one or more options to preconfigure any purchased network services among the one or more network services. Method 400 either may continue onto the process at block 420 or may continue onto the process at block 475 in FIG. 4C following the circular marker denoted, “A.”

Method 400 may further comprise, in response to an order being initiated by the user and in response to receiving a first user selection of at least one option to purchase at least one network service and a second user selection of at least one option to preconfigure the at least one network service, autonomously processing, using the computing system, the order for the at least one network service to be provisioned to the user based at least in part on the first user selection and the second user selection. At block 425, method 400 may comprise provisioning, using the computing system, the at least one network service.

In some embodiments, the computing system may comprise at least one of a web-based digital marketplace computing system, a portal-based digital marketplace computing system, a software application (“app”) -based digital marketplace computing system, a server computer, a customer interface server, a network service reservation and ordering platform server, a gateway controller, a network provisioning server, a cloud computing system, or a distributed computing system, and/or the like. In some instances, the plurality of network services may comprise at least one of a plurality of network service apps, one or more Internet services, one or more wide area network (“WAN”) services, one or more software-defined WAN (“SD-WAN”) services, one or more network security services, one or more telephony services, one or more voice over Internet Protocol (“VoIP) services, or other network services, and/or the like. In some cases, the customer premises may comprise one of a residential customer premises, a business customer premises, a corporate customer premises, an enterprise customer premises, an education facility customer premises, a medical facility customer premises, or a governmental customer premises, and/or the like.

Method 400 may continue onto the process at least one of block 490a-490e in FIG. 4D following the circular marker denoted, “C.”

Referring to FIG. 4B, provisioning, using the computing system, the at least one network service (at block 425) may comprise determining whether a customer premises equipment (“CPE”) has been shipped to a customer premises associated with the user or an entity with which the user is associated (block 430). If so, method 400 may continue onto the process at block 435. If not, method 400 may continue onto the process at block 455.

At block 435, method 400 may comprise determining whether the CPE is installed and operational. If so, method 400 may continue onto the process at block 440. If not, method 400 may continue onto the process at block 450.

At block 440, method 400 may comprise autonomously provisioning, using the computing system, the at least one network service on the CPE based on the first user selection. Method 400, at block 445, may comprise autonomously preconfiguring, using the computing system, the provisioned at least one network service based on the second user selection. In some cases, autonomously provisioning the at least one network service on the CPE may comprise autonomously deploying the at least one network service on the CPE from a network edge platform in proximity to the customer premises.

At block 450, method 400 may comprise sending, using the computing system, a set of instructions for the user to install the CPE at the customer premises. Method 400 may return to the process at block 435. In response to determining that the CPE has been successfully installed at the customer premises (at block 435), the processes at blocks 440 and 445 may be implemented.

At block 455, method 400 may comprise assigning, using the computing system, a CPE to at least one of the entity, the user, or the customer premises, and/or the like; provisioning, using the computing system, the at least one network service on the assigned CPE based on the first user selection (block 460); preconfiguring, using the computing system, the provisioned at least one network service based on the second user selection (block 465); and shipping the assigned CPE to the customer premises with instructions for installing the assigned CPE (block 470).

At block 475 in FIG. 4C (following the circular marker denoted, “A,” in FIG. 4A), method 400 may comprise, in response to receiving at least one of the first user selection or the second user selection, placing, using the computing system, the at least one network service in a shopping cart of the UX platform. Method 400 may further comprise providing, using the computing system and via the UX platform, one or more options to visualize the at least one network service that has been added to the shopping cart (block 480); and generating and presenting, using the computing system and within the UX platform, a visualization of the at least one network service in response to receiving a third user selection of at least one option to visualize the at least one network service that has been added to the shopping cart (block 485).

According to some embodiments, generating and presenting the visualization of the at least one network service (at block 485) may comprise generating and presenting, using the computing system and within the UX platform, a visualization of the at least one network service in relation to other network services associated with at least one of the entity, the user, or the customer premises, and/or the like (block 485a). Alternatively, or additionally, generating and presenting the visualization of the at least one network service (at block 485) may (further) comprise determining, using the computing system, geographical locations or coverages of the at least one network service and any other network services associated with at least one of the entity, the user, or the customer premises, and/or the like, relative to one or more geographical locations associated with the at least one of the entity, the user, or the customer premises, and/or the like (block 485b); and, based on such determination, generating and presenting, using the computing system and within the UX platform, a map-based visualization of the at least one network service in relation to other network services associated with at least one of the entity, the user, or the customer premises and in relation to the one or more geographical locations associated with the at least one of the entity, the user, or the customer premises (block 485c).

With reference to FIG. 4D (following the circular marker denoted, “C”), method 400 may comprise at least one of: initiating, using the computing system, one or more network service updates for the at least one network service via the CPE (block 490a); facilitating, using the computing system, service registration of the at least one network service via the CPE (block 490b); implementing, using the computing system, one or more post-configuration settings for the at least one network service via the CPE (block 490c); tracking, using the computing system, performance of the at least one network service via the CPE (block 490d); or providing, using the computing system, one or more of analytics or insights associated with functioning of the at least one network service to the user (block 490e); and/or the like. In some cases, the at least one network service may comprise at least one network service app. In such cases, the one or more network service updates may comprise one or more network service app updates. The service registration may comprise network service app registration. The one or more post-configuration settings may comprise network service app configuration settings. The performance of the at least one network service may comprise network service app performance. One or more of analytics or insights associated with functioning of the at least one network service may comprise network service app analytics and insights.

### Exemplary System and Hardware Implementation

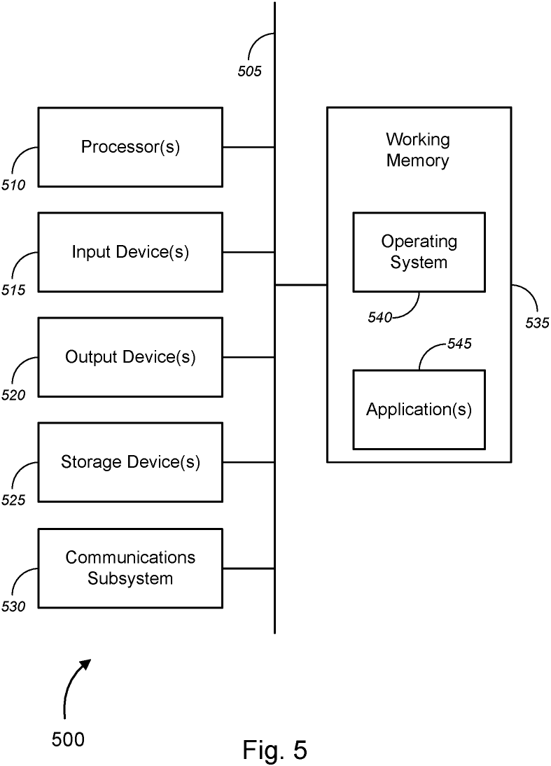

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing system or system platform 105 and 205, marketplace platform 115a, 115b, and 215, network service provisioning system 120, IT platform services system 125 and 225, network service monitoring system 130a, 130b, and 230, user devices 145a-145n and 150a-150n, gateway devices or CPE 155a-155n and 255, edge nodes 160 and 260, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500 - which might represent an embodiment of the computer or hardware system (i.e., computing system or system platform 105 and 205, marketplace platform 115a, 115b, and 215, network service provisioning system 120, IT platform services system 125 and 225, network service monitoring system 130a, 130b, and 230, user devices 145a-145n and 150a-150n, gateway devices or CPE 155a-155n and 255, edge nodes 160 and 260, etc.), described above with respect to FIGS. 1-4 - is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth® device, an 802.11 device, a WiFi device, a WiMax device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

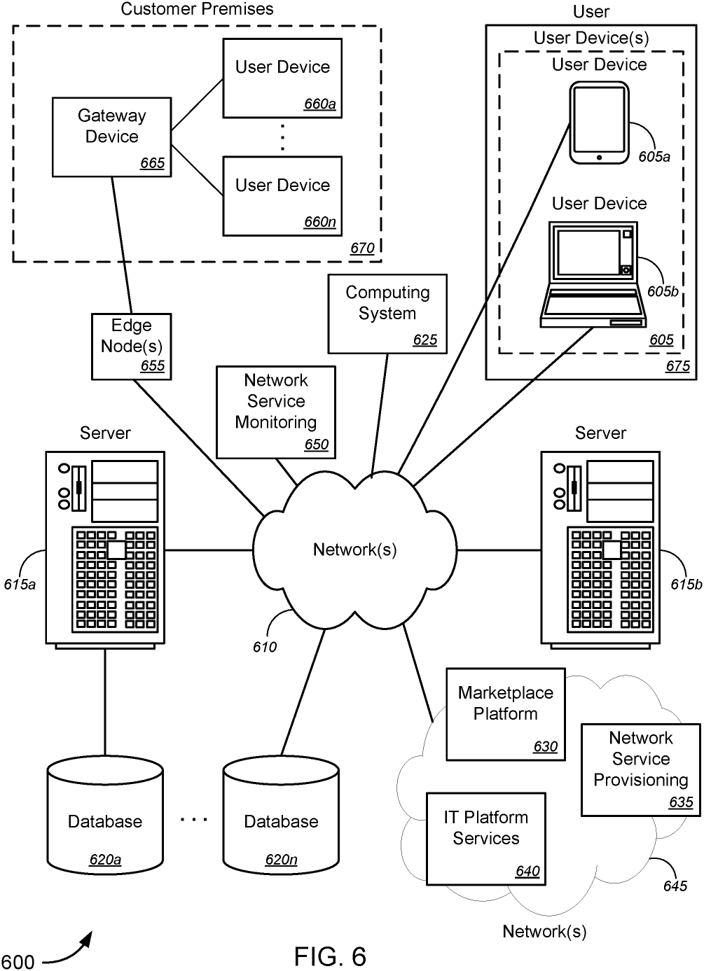

As noted above, a set of embodiments comprises methods and systems for implementing network service ordering and provisioning, and, more particularly, to methods, systems, and apparatuses for implementing a digital marketplace for providing a user experience (“UX”) for customers to order and configure network services that are subsequently autonomously provisioned via a network(s). FIG. 6 illustrates a schematic diagram of a system 600 that can be used in accordance with one set of embodiments. The system 600 can include one or more user computers, user devices, or customer devices 605. A user computer, user device, or customer device 605 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX® or UNIX-like operating systems. A user computer, user device, or customer device 605 can also have any of a variety of applications, including one or more applications configured to perform methods provided by various embodiments (as described above, for example), as well as one or more office applications, database client and/or server applications, and/or web browser applications. Alternatively, a user computer, user device, or customer device 605 can be any other electronic device, such as a thin-client computer, Internet-enabled mobile telephone, and/or personal digital assistant, capable of communicating via a network (e.g., the network(s) 610 described below) and/or of displaying and navigating web pages or other types of electronic documents. Although the exemplary system 600 is shown with two user computers, user devices, or customer devices 605, any number of user computers, user devices, or customer devices can be supported.

Certain embodiments operate in a networked environment, which can include a network(s) 610. The network(s) 610 can be any type of network familiar to those skilled in the art that can support data communications using any of a variety of commercially-available (and/or free or proprietary) protocols, including, without limitation, TCP/IP, SNA®, IPX®, AppleTalk®, and the like. Merely by way of example, the network(s) 610 (similar to network(s) 165, 170, and/or 265a-265b of FIGS. 1 and 2, or the like) can each include a local area network (“LAN”), including, without limitation, a fiber network, an Ethernet network, a Token-Ring® network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth® protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 615. Each of the server computers 615 may be configured with an operating system, including, without limitation, any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 might be a data server, a web server, a cloud computing device(s), or the like, as described above. The data server might include (or be in communication with) a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including, without limitation, web applications (which might, in some cases, be configured to perform methods provided by various embodiments). Merely by way of example, a web application can be implemented as one or more scripts or programs written in any suitable programming language, such as Java®, C, C#™ or C++, and/or any scripting language, such as Perl, Python, or TCL, as well as combinations of any programming and/or scripting languages. The application server(s) can also include database servers, including, without limitation, those commercially available from Oracle®, Microsoft®, Sybase®, IBM®, and the like, which can process requests from clients (including, depending on the configuration, dedicated database clients, API clients, web browsers, etc.) running on a user computer, user device, or customer device 605 and/or another server 615. In some embodiments, an application server can perform one or more of the processes for implementing network service ordering and provisioning, and, more particularly, to methods, systems, and apparatuses for implementing a digital marketplace for providing a user experience (“UX”) for customers to order and configure network services that are subsequently autonomously provisioned via a network(s), as described in detail above. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer, user device, or customer device 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620a-620n (collectively, “databases 620”). The location of each of the databases 620 is discretionary: merely by way of example, a database 620a might reside on a storage medium local to (and/or resident in) a server 615a (and/or a user computer, user device, or customer device 605). Alternatively, a database 620n can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle database, that is adapted to store, update, and retrieve data in response to SQL-formatted commands. The database might be controlled and/or maintained by a database server, as described above, for example.

According to some embodiments, system 600 might further comprise a computing system 625 (similar to computing system or system platform 105 and 205 of FIGS. 1 and 2, or the like), a marketplace platform 630 (similar to marketplace platform 115a, 115b, and 215 of FIGS. 1 and 2, or the like), a network service provisioning system 635 (similar to network service provisioning system 120 of FIG. 1, or the like), an IT platform services system 640 (similar to IT platform services system 125 and 225 of FIGS. 1 and 2, or the like), and a network(s) 645. In some cases, the marketplace platform 630, the network service provisioning system 635, and the IT platform services system 640 may be disposed within network(s) 645, which may communicatively couple with network(s) 610. System 600 may further comprise a network service monitoring system 650 (similar to network service monitoring system 130a, 130b, and 230 of FIGS. 1 and 2, or the like) and an edge node(s) 655 (similar to edge nodes 160 and 260 of FIGS. 1 and 2, or the like), each of which may be disposed within or communicatively couple with network(s) 610. System 670 may further comprise one or more user devices 660a-660n (collectively, “user devices 660” or the like; similar to user devices 145a-145n and 150a-150n of FIGS. 1 and 2, or the like) and gateway device 665 (similar to gateway devices or CPE 155a-155n and 255of FIGS. 1 and 2, or the like), each disposed within customer premises 670 (similar to customer premises 140a-140n of FIG. 1, or the like).

The functions of the system 600 (and its components) are described in greater detail above with respect to FIGS. 1-4.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with-or without-certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
in response to an order being initiated by the user and in response to receiving a first user selection of at least one option to purchase at least one network service and a second user selection of at least one option to preconfigure the at least one network service, autonomously processing, using the computing system, the order for the at least one network service to be provisioned to the user based at least in part on the first user selection and the second user selection, the first and second user selections being made using a user experience (“UX”) platform for a digital marketplace, the UX platform being accessible by the user via a user device over one or more networks;
based on a determination that the user already has a customer premises equipment (“CPE”) installed and operational at a customer premises associated with the user or with an entity with which the user is associated, autonomously provisioning, using the computing system, the at least one network service on the CPE based on the first user selection, and autonomously preconfiguring, using the computing system, the provisioned at least one network service based on the second user selection;
based on a determination that the user does not currently have a CPE installed and operational at the customer premises and based on a determination that a CPE has already been shipped to the customer premises, sending, using the computing system, a set of instructions for the user to install the CPE at the customer premises, and in response to determining that the CPE has been successfully installed at the customer premises, autonomously provisioning, using the computing system, the at least one network service on the CPE based on the first user selection, and autonomously preconfiguring, using the computing system, the provisioned at least one network service based on the second user selection; and
based on a determination that the user does not currently have a CPE installed and operational at the customer premises and based on a determination that a CPE has not already been shipped to the customer premises, assigning, using the computing system, a CPE to at least one of the entity, the user, or the customer premises, provisioning, using the computing system, the at least one network service on the assigned CPE based on the first user selection, preconfiguring, using the computing system, the provisioned at least one network service based on the second user selection, and shipping the assigned CPE to the customer premises with instructions for installing the assigned CPE.

2. The method of claim 1, wherein the computing system comprises at least one of a web-based digital marketplace computing system, a portal-based digital marketplace computing system, a software application (“app”) -based digital marketplace computing system, a server computer, a customer interface server, a network service reservation and ordering platform server, a gateway controller, a network provisioning server, a cloud computing system, or a distributed computing system.

3. The method of claim 1, wherein the plurality of network services comprises at least one of a plurality of network service apps, one or more Internet services, one or more wide area network (“WAN”) services, one or more software-defined WAN (“SD-WAN”) services, one or more network security services, one or more telephony services, one or more voice over Internet Protocol (“VoIP) services, or other network services.

4. The method of claim 1, wherein the customer premises comprises one of a residential customer premises, a business customer premises, a corporate customer premises, an enterprise customer premises, an education facility customer premises, a medical facility customer premises, or a governmental customer premises.

5. The method of claim 1, wherein autonomously provisioning the at least one network service on the CPE comprises autonomously deploying the at least one network service on the CPE from a network edge platform in proximity to the customer premises.

6. The method of claim 1, further comprising at least one of:
initiating, using the computing system, one or more network service updates for the at least one network service via the CPE;
facilitating, using the computing system, service registration of the at least one network service via the CPE;
implementing, using the computing system, one or more post-configuration settings for the at least one network service via the CPE;
tracking, using the computing system, performance of the at least one network service via the CPE; or
providing, using the computing system, one or more of analytics or insights associated with functioning of the at least one network service to the user.

7. The method of claim 6, wherein the at least one network service comprises at least one network service app, wherein:
the one or more network service updates comprise one or more network service app updates;
the service registration comprises network service app registration;
the one or more post-configuration settings comprise network service app configuration settings;
the performance of the at least one network service comprises network service app performance; and
one or more of analytics or insights associated with functioning of the at least one network service comprises network service app analytics and insights.

8. The method of claim 1, further comprising:
providing, using a computing system, a user experience (“UX”) platform for a digital marketplace, the UX platform being accessible by a user via a user device over one or more networks;
providing, using the computing system and via the UX platform, one or more options to purchase, via the digital marketplace, one or more network services among a plurality of network services provided by a service provider; and
providing, using the computing system and via the UX platform, one or more options to preconfigure any purchased network services among the one or more network services.

9. The method of claim 1, further comprising:
generating and presenting, using the computing system and within the UX platform, a visualization of the at least one network service.

10. The method of claim 9, further comprising:
in response to receiving at least one of the first user selection or the second user selection, placing, using the computing system, the at least one network service in a shopping cart of the UX platform; and
providing, using the computing system and via the UX platform, one or more options to visualize the at least one network service that has been added to the shopping cart;
wherein generating and presenting the visualization of the at least one network service is in response to receiving a third user selection of at least one option to visualize the at least one network service that has been added to the shopping cart.

11. The method of claim 9, wherein generating and presenting the visualization of the at least one network service comprises generating and presenting, using the computing system and within the UX platform, a visualization of the at least one network service in relation to other network services associated with at least one of the entity, the user, or the customer premises.

12. The method of claim 9, wherein generating and presenting the visualization of the at least one network service comprises:
determining, using the computing system, geographical locations or coverages of the at least one network service and any other network services associated with at least one of the entity, the user, or the customer premises relative to one or more geographical locations associated with the at least one of the entity, the user, or the customer premises; and
based on such determination, generating and presenting, using the computing system and within the UX platform, a map-based visualization of the at least one network service in relation to other network services associated with at least one of the entity, the user, or the customer premises and in relation to the one or more geographical locations associated with the at least one of the entity, the user, or the customer premises.

13. A system, comprising:
a computing system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
in response to an order being initiated by the user and in response to receiving a first user selection of at least one option to purchase at least one network service and a second user selection of at least one option to preconfigure the at least one network service, autonomously process the order for the at least one network service to be provisioned to the user based at least in part on the first user selection and the second user selection, the first and second user selections being made using a user experience (“UX”) platform for a digital marketplace, the UX platform being accessible by the user via a user device over one or more networks;
based on a determination that the user already has a customer premises equipment (“CPE”) installed and operational at a customer premises associated with the user or with an entity with which the user is associated, autonomously provision the at least one network service on the CPE based on the first user selection, and autonomously preconfigure the provisioned at least one network service based on the second user selection;
based on a determination that the user does not currently have a CPE installed and operational at the customer premises and based on a determination that a CPE has already been shipped to the customer premises, send a set of instructions for the user to install the CPE at the customer premises, and in response to determining that the CPE has been successfully installed at the customer premises, autonomously provision the at least one network service on the CPE based on the first user selection, and autonomously preconfigure the provisioned at least one network service based on the second user selection; and
based on a determination that the user does not currently have a CPE installed and operational at the customer premises and based on a determination that a CPE has not already been shipped to the customer premises, assign a CPE to at least one of the entity, the user, or the customer premises, provision the at least one network service on the assigned CPE based on the first user selection, preconfigure the provisioned at least one network service based on the second user selection, and ship the assigned CPE to the customer premises with instructions for installing the assigned CPE.

14. The system of claim 13, wherein the computing system comprises at least one of a web-based digital marketplace computing system, a portal-based digital marketplace computing system, a software application (“app”) -based digital marketplace computing system, a server computer, a customer interface server, a network service reservation and ordering platform server, a gateway controller, a network provisioning server, a cloud computing system, or a distributed computing system.

15. The system of claim 13, wherein the plurality of network services comprises at least one of a plurality of network service apps, one or more Internet services, one or more wide area network (“WAN”) services, one or more software-defined WAN (“SD-WAN”) services, one or more network security services, one or more telephony services, one or more voice over Internet Protocol (“VoIP) services, or other network services.

16. A method, comprising:
providing, using a computing system, a user experience (“UX”) platform for a digital marketplace with which to order provisioning of network services to a customer premises that is associated with a user or with an entity with which the user is associated, with consistent user purchase experience without interaction with sales personnel associated with a service provider providing the network services, the UX platform being accessible by the user via a user device over one or more networks,
wherein the network services comprise at least one of one or more network service apps, one or more Internet services, one or more wide area network (“WAN”) services, one or more software-defined WAN (“SD-WAN”) services, one or more network security services, one or more telephony services, one or more voice over Internet Protocol (“VoIP) services, or other network services.

17. The method of claim 16, wherein the computing system comprises at least one of a web-based digital marketplace computing system, a portal-based digital marketplace computing system, a software application (“app”) -based digital marketplace computing system, a server computer, a customer interface server, a network service reservation and ordering platform server, a gateway controller, a network provisioning server, a cloud computing system, or a distributed computing system.

18. The method of claim 15, further comprising:
providing, using the computing system and via the UX platform, one or more options to visualize one or more network services that the user has added to a shopping cart of the UX platform to order provisioning of the one or more network services; and
in response to receiving a third user selection of at least one option to visualize the at least one network service that has been added to the shopping cart, generating and presenting, using the computing system and within the UX platform, a visualization of the one or more network services.

19. The method of claim 18, wherein generating and presenting the visualization of the one or more network services comprises generating and presenting, using the computing system and within the UX platform, a visualization of the one or more network services in relation to other network services associated with at least one of the entity, the user, or the customer premises.

20. The method of claim 18, wherein generating and presenting the visualization of the one or more network services comprises:
determining, using the computing system, geographical locations or coverages of the one or more network services and any other network services associated with at least one of the entity, the user, or the customer premises relative to one or more geographical locations associated with the at least one of the entity, the user, or the customer premises; and
based on such determination, generating and presenting, using the computing system and within the UX platform, a map-based visualization of the one or more network services in relation to other network services associated with at least one of the entity, the user, or the customer premises and in relation to the one or more geographical locations associated with the at least one of the entity, the user, or the customer premises.
